(19) United States
(12) Patent Application Publication
(10) Pub. No.: US 2023/0382096 A1
(43) Pub. Date: Nov. 30, 2023

(54) A METHOD TO PRODUCE A LAMINATED SUBSTRATE WITH AN EMBOSSED STRUCTURE

(71) Applicant: Vâlinge Innovation AB, Viken (SE)

(72) Inventors: Christoffer NILSSON, Helsingborg (SE); Filip SKÖLD, Löddeköpinge (SE); Per NYGREN, Ramlösa (SE); Per JOSEFSSON, Ramlösa (SE)

(73) Assignee: Vâlinge Innovation AB, Viken (SE)

(21) Appl. No.: 18/325,538

(22) Filed: May 30, 2023

(30) Foreign Application Priority Data
May 31, 2022 (SE) 2250649-7

(51) Int. Cl. B32B 37/18; B32B 38/06; B32B 37/10; B32B 37/06; B32B 27/08; B32B 27/30

(52) U.S. Cl. CPC B32B 37/182; B32B 38/06; B32B 37/10; B32B 37/06; B32B 27/08; B32B 27/304; B32B 2451/00; B32B 2607/00; B32B 2250/02

(57) ABSTRACT

A method to produce a laminated substrate with an embossed structure, including: providing a polymer based film printed by at least a first gravure cylinder forming a first pattern and a second gravure cylinder forming a second pattern, wherein a circumference of the second gravure cylinder exceeds a circumference of the first gravure cylinder, applying the polymer based film on a substrate including a polymer based material, pressing said polymer based film to the substrate, thereby forming a laminated substrate, and embossing the laminated substrate by an embossing device such that the laminated substrate obtains an embossed structure, wherein a perimeter of the embossing device corresponds to the circumference of the first gravure cylinder or to the circumference of the second gravure cylinder.

### CROSS REFERENCE TO RELATED APPLICATIONS

The present application claims the benefit of Swedish Application No. 22506497, filed on May 31, 2022. The entire contents of Swedish Application No. 22506497 are hereby incorporated herein by reference in their entirety.

### TECHNICAL FIELD

Embodiments of the present disclosure relate to a method to produce a laminated substrate with an embossed structure.

### TECHNICAL BACKGROUND

Panels such as building panels may be provided with a print for decorative purposes. The print may be a wood grain pattern simulating wood. In other examples, the print may be a stone pattern simulating stone, or a fantasy pattern. In order to increase the realistic look and feel of the panel, the panel may be provided with an embossed structure, comprising embossed portions and protrusions. The embossed structure may be in register with the print, such that the embossed structure matches the elements of the print. The elements of the print may be grains, knots, medullary rays, and other elements depicting structures in wood.

The print may be printed by various methods. One method commonly used is rotogravure printing, wherein the pattern is printed by several gravure cylinders. Digital printing allows more variations in the print, thus being more flexible compared to engraving gravure cylinders.

During recent years in the field of flooring, vinyl tiles have gained increasingly success. One such type of tiles is SPC (Stone Plastic Composite), wherein the core is formed in a continuous process by extruding the core material. The pattern is provided by a separate print film, which most commonly is printed by rotogravure printing. The print film and a protective layer arranged above the print film is pressed to the core by one or several pressing rollers. An embossed structure may be pressed into the panel by an embossing roller.

Due to the cost for engraving gravure cylinders and embossing rollers the number of unique designs limited. Thus, after dividing the substrate into individual panels, a certain repetition of the pattern occurs after a number of panels. When installing the floor such repetitions are undesired. Increasing the number of variations and reduce the number of identical panels are therefore desired to improve the realistic look and feel of the floor.

### SUMMARY

It is an object of at least embodiments of the present disclosure to provide an improvement over the above described techniques and known art.

According to a first aspect of the disclosure, a method to produce a laminated substrate with an embossed structure is provided. The method comprises providing a polymer based film printed by at least a first gravure cylinder forming a first pattern and a second gravure cylinder forming a second pattern, wherein a circumference of the second gravure cylinder exceeds a circumference of the first gravure cylinder, applying the polymer based film on a substrate comprising a polymer based material, pressing said polymer based film to the substrate, thereby forming a laminated substrate, and embossing the laminated substrate by an embossing device such that the laminated substrate obtains an embossed structure, wherein a perimeter of the embossing device corresponds to the circumference of the first gravure cylinder or to the circumference of the second gravure cylinder.

The terms first and second are not limited to any subsequent arrangement but is solely intended as to identify the gravure cylinders.

The first pattern and the second pattern may not be identical. The first pattern may be different from the second pattern.

As an alternative, one of the first gravure cylinder or the second gravure cylinder may be replaced by a digital printing method, such as inkjet printing.

The embossing device may be an embossing roller or an embossing belt.

The embossed structure of the embossing device may correspond, completely or at least partly, to the first pattern or to the second pattern. Thereby, embossed structure may be in register, completely or at least partly, with the first pattern or with the second pattern. Typically, a pattern of a gravure cylinder comprises a large number of design elements. An embossed structure corresponding to a gravure cylinder pattern typically comprises a portion of the design elements. If a pattern of a gravure cylinder is very complex or crowded, a complete embossing in register with such pattern may have a disadvantageous appearance. Thus, the embossed structure may be in register with, all of or at least a portion of, the first pattern or with the second pattern.

Pressing and embossing may take place simultaneously. Pressing and embossing may be performed by a common device, such as an embossing roller or embossing belt configured for both pressing and embossing.

The substrate may have a length and a width. The polymer based film may have a length and a width. The length direction of the polymer based film may be substantially parallel to the length direction of the substrate.

The perimeter of the embossing device may correspond to the circumference of the first gravure cylinder such that the first pattern formed by the first gravure cylinder is at least partly in register with the embossed structure.

The second pattern formed by the second gravure cylinder may not be in register with, or at least not be completely in register with, the embossed structure.

The second pattern formed by the second gravure cylinder is typically not register with, or only in register with a portion of, the embossed structure.

The first pattern may comprise a first set of design elements and the second pattern may comprise a second set of design elements, wherein the embossed structure may be in register with the first set of design elements.

The perimeter of the embossing device may correspond to the circumference of the second gravure cylinder such that the second pattern formed by the second gravure cylinder is in register with the embossed structure.

The perimeter of the embossing device may correspond to the circumference of the second gravure cylinder such that the second pattern formed by the second gravure cylinder is in register with the embossed structure or a portion thereof.

The first pattern formed by the first gravure cylinder may not be, or at least not be completely, in register with the embossed structure.

The first pattern may comprise a first set of design elements and the second pattern may comprise a second set of design elements, wherein the embossed structure may be in register with the second set of design elements.

The first pattern and/or the second pattern may be a wood grain pattern.

The first pattern or the second pattern may add at least one knot, crack and/or medullary ray to the other of the first pattern or the second pattern.

The method may further comprise dividing the laminated substrate into panels, wherein a length of a panel may substantially correspond to the perimeter of the embossing device.

A length of a panel may substantially correspond to the circumference of the first gravure cylinder or to the circumference of the second gravure cylinder.

The length of a panel may correspond to a portion of the circumference of the first gravure cylinder or of the circumference of the second gravure cylinder, if the first or second gravure cylinder comprises a pattern repetition comprising more than one pattern. The length of the panel may correspond to a length of an individual pattern in the pattern repetition of the first pattern or of the second pattern. Each pattern in the pattern repetition may have an equal length.

The panel may be a plank or a tile.

Each panel may have an equal length.

The substrate may be formed by a continuous process.

The polymer based film may be continuously applied on the substrate.

The polymer based film may be applied inline with the production process of the substrate.

Forming the substrate and applying the polymer based film may be a continuous process.

The substrate may be formed by extruding.

A barrel temperature of the extruder may be 145-225° C.

The polymer based film may be applied to the substrate prior to cooling the substrate.

The polymer of the polymer based film may be a thermoplastic polymer.

The polymer of the polymer based film may be a thermosetting polymer.

The polymer based film may be free from paper, such as being non paper based.

The polymer based film may be made of a polymeric material, such as a thermoplastic or a thermoset.

The polymer based film may be a PVC film.

The polymer based material of the substrate may be a thermoplastic material or a thermosetting material.

The substrate may further comprise fillers. The fillers may be organic and/or inorganic. The fillers may be one or more of: calcium carbonate, chalk, limestone, talc, stone dust, fly ash, wood dust, grounded risk husk, cork, and bamboo dust.

Pressing may comprise applying heat and pressure.

The method may further comprise applying a protective layer to said polymer based film prior to embossing.

The protective layer may be a polymer based film such a thermoplastic film or a thermosetting film.

According to a second aspect, a method to produce a laminated substrate with an embossed structure is provided. The method comprises:
providing a polymer based film having a first pattern printed by at least a first gravure cylinder and a second pattern printed by digital printing,
applying the polymer based film on a substrate comprising a polymer based material,
pressing said polymer based film to the substrate, thereby forming a laminated substrate, and
embossing the laminated substrate by an embossing device such that the laminated substrate obtains an embossed structure, wherein a perimeter of the embossing device corresponds to a circumference of the first gravure cylinder, or to a pattern repetition length of the second pattern.

The digital printing method may be inkjet printing.

The first pattern and the second pattern may not be identical. The first pattern and the second pattern may be different.

The pattern repetition length is measured in the length direction of the polymer based film.

If the second pattern comprises two or more individual patterns, the patterns are subsequent each other in a length direction of the polymer based film. Each pattern in the pattern repetition is not identical to another pattern in the pattern repetition.

The pattern repetition length may be measured from the beginning of the first pattern in the pattern repetition to the end of the last pattern in the pattern repetition, as measured in the length direction of the polymer based film.

If the second pattern comprises one pattern, the length of said pattern in the length direction of the polymer based film corresponds to the length of the pattern repetition in the length direction of polymer based film.

The length of the pattern repetition of the second patterns may exceed the circumference of the first gravure cylinder.

The substrate may have a length and a width. The polymer based film may have a length and a width. The length direction of the polymer based film may be substantially parallel to the length direction of the substrate.

The embossing device may be an embossing roller or an embossing belt.

The embossed structure of the embossing device may correspond, completely or at least partly, to the first pattern or to the second pattern. Thereby, embossed structure may be in register, completely or at least partly, with the first pattern or with the second pattern.

Pressing and embossing may take place simultaneously. Pressing and embossing may be performed by a common device, such as an embossing roller or embossing belt configured for both pressing and embossing.

The perimeter of the embossing device may correspond to the circumference of the first gravure cylinder such that the first pattern formed by the first gravure cylinder is at least partly in register with the embossed structure.

The second pattern formed by digital printing may not be, or at least not completely, in register with the embossed structure.

The first pattern may comprise a first set of design elements and the second pattern may comprise a second set of design elements, wherein the embossed structure may be in register with the first set of design elements.

The perimeter of the embossing device may correspond to the length of the pattern repetition of the second pattern such that the second pattern formed by digital printing is in register with the embossed structure. The perimeter of the embossing device may correspond to the length of the pattern repetition of the second pattern such that at least a part of the second pattern formed by digital printing is in register with the embossed structure.

The first pattern formed by the first gravure cylinder may not be, or at least not completely, in register with the embossed structure.

The first pattern may comprise a first set of design elements and the second pattern may comprise a second set of design elements, wherein the embossed structure may be in register with the second set of design elements.

The first pattern and/or the second pattern may be a wood grain pattern.

The first pattern or the second pattern may add at least one knot, crack and/or at least one medullary ray to the other of the first pattern or the second pattern.

The method may further comprise dividing the laminated substrate into panels, wherein a length of a panel may substantially correspond to the perimeter of the embossing device.

A length of a panel may substantially correspond to a length of the first pattern or to a pattern repetition length of the second pattern.

The length of a panel may correspond to a portion of the circumference of the first gravure cylinder or a portion of the pattern repetition length of the second pattern. The length of the panel may correspond to a length of an individual pattern of the pattern repetition of the first pattern or of the second pattern. Each pattern in the pattern repetition may have an equal length.

The panel may be a plank or a tile.

The substrate may be formed by a continuous process.

The polymer based film may be continuously applied on the substrate.

The polymer based film may be applied inline with the production process of the substrate.

Forming the substrate and applying the polymer based film may be a continuous process.

The substrate may be formed by extruding.

A barrel temperature of the extruder may be 145-225° C.

The polymer based film may be applied to the substrate prior to cooling the substrate.

The polymer of the polymer based film may be a thermoplastic polymer.

The polymer of the polymer based film may be a thermosetting polymer.

The polymer based film may be free from paper, such as being non paper based.

The polymer based film may be made of a polymeric material, such as a thermoplastic or a thermoset.

The polymer based film may be a PVC film.

The polymer based material of the substrate may be a thermoplastic material or a thermosetting material.

The substrate may further comprise fillers. The fillers may be organic and/or inorganic. The fillers may be one or more of: calcium carbonate, chalk, limestone, talc, stone dust, fly ash, wood dust, grounded risk husk, cork, and bamboo dust.

Pressing may comprise applying heat and pressure.

The method may further comprise applying a protective layer to said polymer based film prior to embossing.

The protective layer may be a polymer based film such a thermoplastic film or a thermosetting film.

### BRIEF DESCRIPTION OF THE DRAWINGS

The present disclosure will by way of example be described in more detail with reference to the appended schematic drawings, which show embodiments of the present disclosure.

FIG. 1 shows schematically a rotogravure printing process of a polymer based film.

FIG. 2 shows schematically a combined printing process, including digital printing and rotogravure printing, of a polymer based film.

FIG. 3A shows a portion of a printed polymer based film, comprising a first pattern.

FIG. 3B shows a portion of a printed polymer based film, comprising a second pattern.

FIG. 3C shows a portion of a printed polymer based film, comprising first patterns and second patterns.

FIG. 4 shows schematically a process for forming a laminated substrate according to a first example.

FIG. 5 shows schematically a process for forming a laminated substrate according to a second example.

FIG. 6 shows schematically a process for forming a laminated substrate according to a third example.

FIG. 7 shows a top view of the laminated substrate according to a first example.

FIG. 8 shows a top view of the laminated substrate according to a second example.

FIG. 9 shows a top view of the laminated substrate according to a third example.

### DETAILED DESCRIPTION

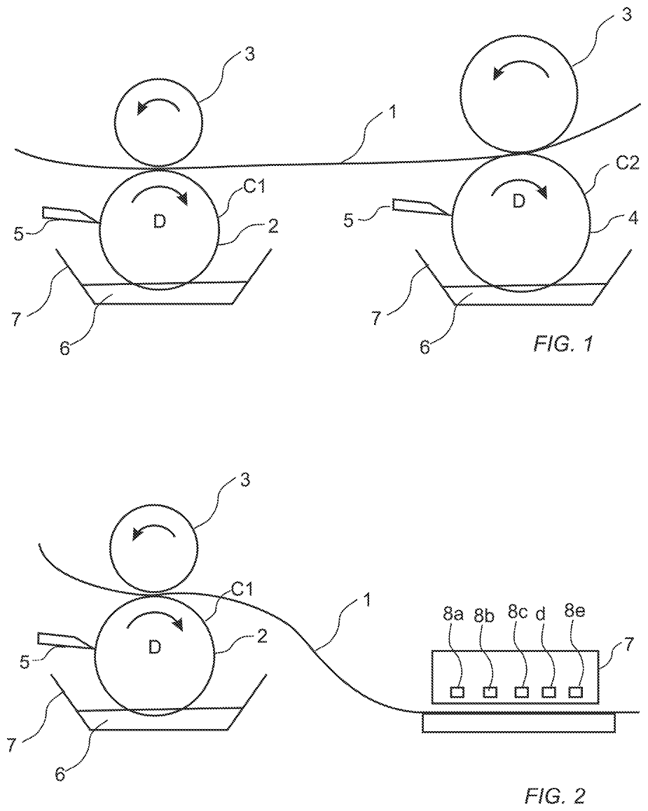

FIG. 1 shows schematically a rotogravure printing process in cross-section. In rotogravure printing, one or more gravure cylinders apply ink on the substrate to be printed. Conventionally, one gravure cylinder applies one colour. For CMYK, four gravure cylinders are included in the rotogravure printing process. In FIG. 1, the gravure cylinders are schematically shown in cross-section.

In rotogravure printing, ink 6 is placed in an ink tray 7 and the gravure cylinder 2, 4 is immersed in the ink tray 7 to convey ink 6 from the ink tray 7 to the substrate to be printed. The gravure cylinders 2, 4 are engraved with a pattern. A doctor blade 5 removes excess ink 6 from the gravure cylinder 2, 4 such that ink 6 is only present in recesses of the engraved pattern of the gravure cylinder. The substrate passes between the gravure cylinder 2, 4 and an impression roller 3. Thereby, ink 6 is transferred from the gravure cylinder 2, 4 to a surface of the substrate. The process is repeated for every colour applied.

In the present disclosure, the substrate to be printed is a polymer based film 1. The polymer based film 1 may be a thermoplastic film. The polymer based film 1 may be a thermosetting film. In one example, the polymer based film 1 may be free from paper.

The polymer based film 1 may be of a polymer material. The polymer material may be a thermoplastic or a thermoset.

The polymer based film 1 may be of, or comprise, polyvinyl chloride (PVC), polyester, polypropylene (PP), polyethylene (PE), polystyrene (PS), thermoplastic polyurethane (PU), thermosetting polyurethane (PU), polyethylene terephthalate (PET), polyacrylate, methacrylate, polycarbonate, polyvinyl butyral, polybutylene terephthalate, or a combination thereof.

In one example, the polymer based film 1 is a PVC film. In another example, the polymer based film may be a thermosetting PU film.

The polymer based film 1 may have thickness of 0.01-0.1 mm.

The polymer based film 1 may have a rectangular shape, such as having a length and a width. The length may exceed the width of the polymer based film 1.

The polymer based film 1 may have a size substantially corresponding to the size of a substrate, to which the polymer based film 1 is to be applied in further step. The polymer based film 1 may have a width of 1-1.5 m, such as 1 m or 1.3 m.

In one example, the polymer based film 1 is printed by a rotogravure printing process as described with reference to FIG. 1.

The polymer based film 1 is printed by a first gravure cylinder 2 being engraved with one or more patterns, as seen in the rotational direction of the first gravure cylinder 2.

The first gravure cylinder 2 has a circumference C1. The first gravure cylinder 2 has a rotation axis which may be arranged parallel to a width direction of the polymer based film 1 to be printed. The first gravure cylinder 2 may have length extension parallel to the width direction of the polymer based film 1 to be printed.

Conventionally, the circumference C1 of the first gravure cylinder 2 is less than the length of the polymer based film 1, such that said one or more patterns of the first gravure cylinder 2 is repeated on the polymer based film 1. Said one or more patterns define a pattern repetition, having a pattern repetition length. Each pattern of the pattern repetition is unique and is not identical or equal to another pattern of the pattern repetition. The pattern repetition length substantially corresponds to the circumference C1 of the first gravure cylinder 2.

The polymer based film 1 is also printed by a second gravure cylinder 4, being engraved with one or more patterns, as seen in the rotational direction of the second gravure cylinder 4. The second gravure cylinder 4 has a circumference C2 not being the same as the circumference of the first gravure cylinder 2. The circumference C2 of the second gravure cylinder 4 may exceed the circumference C1 of the first gravure cylinder 2.

The second gravure cylinder 4 may be located after the first gravure cylinder 2 in a printing direction, or may be located before the first gravure cylinder 2 in the printing direction. The terms first and second are only used to identify one gravure cylinder from the other gravure cylinder.

The second gravure cylinder 4 has a rotation axis which may be arranged parallel to a width direction of the polymer based film 1 to be printed. The second gravure cylinder 4 may have length extension parallel to the width direction of the polymer based film 1 to be printed.

Conventionally, the circumference C2 of the second gravure cylinder 4 is less than the length of the polymer based film 1, such that said one or more patterns of the second gravure cylinder 4 is repeated on the polymer based film 1. Said one or more patterns define a pattern repetition, having a pattern repetition length. Each pattern of the pattern repetition is unique and is not identical or equal to another pattern of the pattern repetition. The pattern repetition length substantially corresponds to the circumference C2 of the second gravure cylinder 4.

Since the circumference C1 of the first gravure cylinder 2 is not equal to the circumference C2 of the second gravure cylinder 4, the pattern repetition lengths of the gravure cylinders 2, 4 do not match. If the circumference C2 of the second gravure cylinder 4 exceeds the circumference C1 of the first gravure cylinder 2, the pattern repetition length of the second gravure cylinder 4 exceeds the pattern repetition length of the first gravure cylinder 2. Thereby, elements printed by the second gravure cylinder 4 will be displaced in relation to the pattern repetition of the first gravure cylinder 2.

In the following, examples wherein the pattern is a wood grain pattern will be described. However, in other examples, the pattern may be any type of pattern such as a stone pattern, a tile pattern, a fantasy pattern, etc.

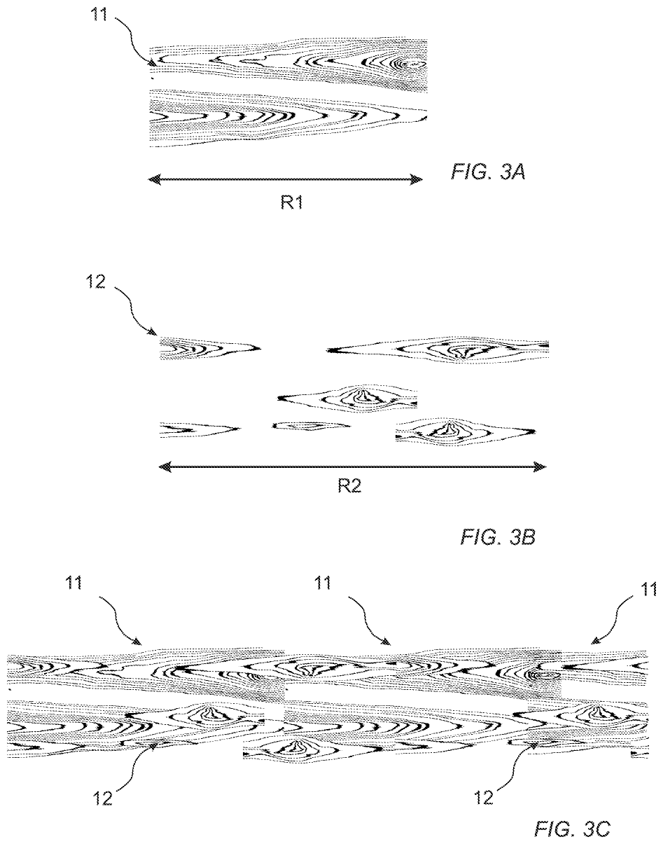

The first gravure cylinder 2 may print a first pattern. The first pattern may represent a main pattern. The first pattern may be a wood grain pattern. The first pattern may comprise one or several patterns forming a pattern repetition. The second gravure cylinder 4 may print a second print. The second gravure cylinder 4 may print additional elements on the first print. The additional elements may be wood grains, knots and/or medullary rays. The additional elements may add elements to the main pattern. Since the circumference C2 of the second gravure cylinder 4 differs from the circumference C1 of the first gravure cylinder 2, the elements will be printed on different positions in respect of the first pattern printed by the first gravure cylinder 2. Thereby, the print provided by the combination of the first gravure cylinder 2 and the second gravure cylinder 4 is not repeated, as will be further described with reference to FIGS. 3A-C.

In the above, the rotogravure printing has been described with reference to the first gravure cylinder 2 and the second gravure cylinder 4, but the skilled person understands that the process is repeated for each colour forming the print. Each colour forming the print is applied by individual gravure cylinders. The first gravure cylinder 2 can be seen as representing a group of first gravure cylinders 2 applying the first pattern, wherein the first gravure cylinders 2 each have the circumference C1. The second gravure cylinder 4 may be seen as representing a group of second gravure cylinders 4 applying the second pattern, wherein the second gravure cylinders 4 each have the circumference C2.

As an alternative or complement to the example described with reference to FIG. 1, digital printing may be combined with rotogravure printing, as will be described with reference to FIG. 2.

In FIG. 2, the polymer based film 1 of the type described above with reference to FIG. 1 is printed by a first rotogravure cylinder 2 having a circumference C1. The first rotogravure cylinder 2 may correspond to the first rotogravure cylinder 2 or to the second rotogravure cylinder 4 described above with reference to FIG. 1.

In addition to rotogravure printing, the polymer based film 1 is printed by a digital printing method, for example by inkjet printing as disclosed in FIG. 2.

Digital printing offers a more flexible printing process, compared to rotogravure printing wherein each individual design requires individual engraving of gravure cylinders 2. An example of a digital printing method is inkjet printing with an inkjet printer 7, which is shown schematically in FIG. 2.

In an example of inkjet printing, the polymer based film 1 to be printed is conveyed below a number of print bars 8a-e. The print bars 8a-e may extend transverse to the conveying direction, or printing direction. The print bars 8a-e may each comprise a number of ink-jet print heads. The inkjet print heads eject drops of ink on the substrate.

The polymer based film 1 may be printed by digital printing subsequent to rotogravure printing, or vice versa.

A main pattern, such as a wood grain pattern, may be printed by the first rotogravure cylinder 2, and the inkjet printing method prints additional elements, such as wood grains, knots and or medullary rays, to the main pattern. The additional elements may be printed by digital printing to avoid repetition of the pattern of the polymer based film 1. Although the pattern printed by the first gravure cylinder 2 may be repeated on the polymer based film 1, the additional elements printed by digital printing adds elements which avoids that the overall pattern of the polymer based film 1 contains repetitions.

FIGS. 3A-C show examples of a portion of the printed polymer based film 1. FIG. 3A shows a first pattern 11. The first pattern 11 shown in FIG. 3A may form a main pattern. The first pattern 11 may be printed by the first gravure cylinder described above with reference to FIG. 2.

The polymer based film 1 is printed with one pattern, i.e., the first pattern 11, in the length direction of the printed polymer based film 1. In this example, the pattern repetition only comprises one individual pattern. The length of the pattern, in the length direction of the polymer based film 1, corresponds to the pattern repetition length R1. The pattern repetition length R1 substantially corresponds to the circumference C1 of the first gravure cylinder used for printing the pattern.

The first pattern 11 shown in FIG. 3A may comprise wood elements, such as wood grains, knots and or medullary rays.

In FIG. 3A, only a portion of the print of the polymer based film 1 is shown in the width direction of the polymer based film 1. The width of the print on the polymer based film 1 may be substantially the same as the width of the polymer based film 1. Consequently, only a portion of the first pattern 11 is shown in the width direction of the printed polymer based film 1. The first pattern 11, and the second pattern 12 described below, can be seen as representing a set of first patterns and a set of second patterns, respectively, in the width direction of the printed polymer based film 1.

The first pattern 11 may be repeated in the length direction of the polymer based film 1.

FIG. 3B shows a second pattern 12. The second pattern 12 may be printed by the second gravure cylinder 4 described above with reference to FIG. 1. The second pattern 12 may comprise design elements such as wood grains, knots and or medullary rays. In this example, the pattern repetition only comprises one individual pattern. The length of the pattern, in the length direction of the polymer based film 1, corresponds to the pattern repetition length R2. The pattern repetition length R2 substantially corresponds to the circumference C2 of the second gravure cylinder 4 used for printing the pattern.

As seen in FIGS. 3A and 3B, the pattern repetition length R2 of the second pattern 12 exceeds the pattern repetition length R1 of the first pattern 11.

FIGS. 3C shows the first pattern 11 and the second pattern 12 together on the polymer based film 1. As the pattern repetition length L2 of the second pattern 12 exceeds the pattern repetition length R1 of the first pattern 11, the overall pattern, formed by the first pattern 11 and the second pattern 12 together, is not repeated on a length of polymer based film 1. The second pattern 12 adds elements to the first pattern 11 that avoids complete repetition of the first pattern 11 on the polymer based film 1.

If the second pattern 12 is printed by digital printing, the second pattern 12 may not be repeated on the polymer based film 1. In other words, the pattern repetition length R2 may substantially correspond to the length of the polymer based film. Elements printed by digital printing may be adapted to the pattern of the first pattern 11 in order to avoid repetition. Elements may be printed by digital printing to reduce the visual impression of repetition of the first pattern 11.

The first pattern 11 may be formed of a first set of design elements, as shown in FIG. 3A. the first set of design elements may form the main pattern. The second pattern 12 may be formed of a second set of design elements, as shown in FIG. 3B. The second set of design elements may form the additional elements, such as holes, cracks and/or medullary rays. The first set of design elements and the second set of design elements together form the combined pattern, as shown in FIG. 3A-C.

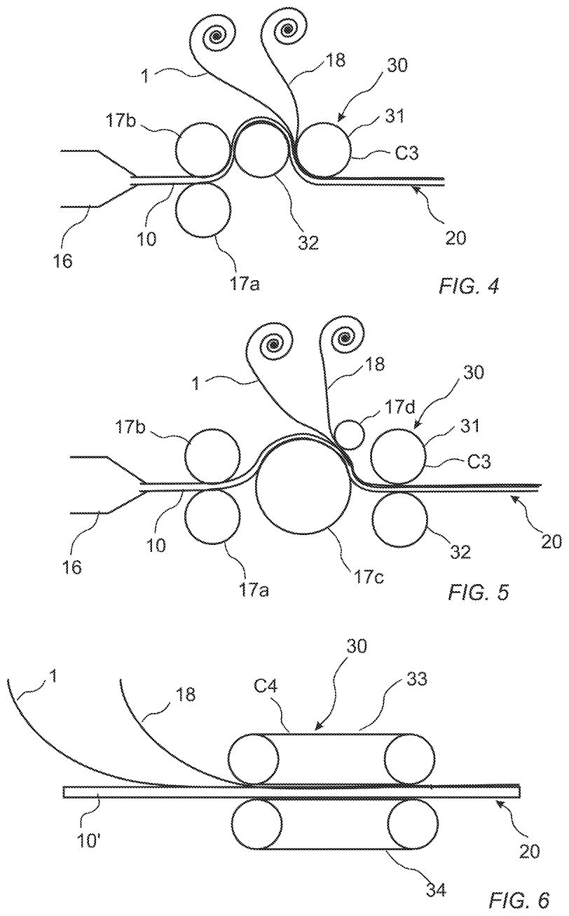

FIG. 4 shows a continuous process for forming a laminated substrate. The layers of the laminated substrate may be applied and joined inline in the process.

In the process shown in FIG. 4, a substrate 10 is produced in an extrusion process by an extruder 16, or by a co-extruder. Thereby, the substrate 10 is an extruded substrate. The substrate 10 is formed in a continuous process.

The substrate 10 may have a rectangular shape, for example, having a length exceeding a width.

The substrate 10 may comprise a polymer based material. The polymer based material may be a thermoplastic or a thermoset. The polymer based material may be, or comprise polyvinyl chloride (PVC), polyester, polypropylene (PP), polyethylene (PE), polystyrene (PS), thermoplastic polyurethane (PU), thermosetting polyurethane (PU), polyethylene terephthalate (PET), polyacrylate, methacrylate, polycarbonate, polyvinyl butyral, polybutylene terephthalate, or a combination thereof. The substrate 10 may comprise 10-60 wt % of the polymer material.

The substrate 10 may further comprises fillers. The fillers may be organic and/or inorganic. The organic fillers may be wood dust, grounded risk husk, cork, bamboo dust. The inorganic fillers may be calcium carbonate, chalk, limestone, talc, stone dust, fly ash. The substrate 10 may comprise 30-90 wt % of said fillers.

The substrate 10 may further comprise additives, such as impact modifier, stabilizers, lubricants, pigments, foaming agent, and/or plasticizer. The substrate 10 may further comprise pigments.

In one example, the substrate 10 may comprise 10-30 wt % PVC, 50-90 wt % chalk, and 0-20 wt % additives. Such a substrate 10 may be of a type conventionally referred to as SPC.

A feeding speed of the continuous process comprising the extruder 16, or co-extruder, may be 0.5-12 m/min, such as 1-10 m/min or 1.5-9.0 m/min.

A barrel temperature of the extruder 16 may be 145-225° C. A barrel temperature of the extruder 16 may be 145-225° C. when extruding PVC. Alternatively, or additionally, an extrudate temperature directly after forming may be 90-280° C. When the substrate 10 comprising PVC, the extrudate temperature may be 90-225° C., preferably 145-220° C.

The substrate 10 may be calendered by passing one or more calender rollers 17a, 17b such that the substrate 10 obtains a desired thickness. After calendering, the substrate 10 may have a thickness of 2-10 mm. As an alternative or complement, the substrate 10 may be pressed to the desired thickness.

A feeding speed of the continuous process comprising the extruder 16, or co-extruder, and calender roller arrangement 17a, 17b may be 0.5-12 m/min, such as 1-10 m/min or 1.5-9.0 m/min.

After calendering, the substrate 10 may be feed over a roller 32.

After calendering, the printed polymer based film 1 described above with reference to FIGS. 1, 2, and 3A-C is applied on a first surface of the substrate 10. The polymer based film 1 may have been printed by rotogravure printing as described above with reference to FIG. 1, or may have been printed by the combined rotogravure and digital printing as described above with reference to FIG. 2.

The printed polymer based film 1 may be continuously applied on the substrate 10.

The printed polymer based film 1 may be applied to the substrate 10 prior to cooling the substrate 10.

The printed polymer based film 1 may be applied on the substrate 10 such as that the length direction of the printed polymer based film 1 is substantially parallel to a length direction of the substrate 10.

In FIG. 4, a protective layer 18 is applied on the printed polymer based film 1. The protective layer 18 may be a protective film, such as a polymer based film. The polymeric material of the protective film may be a thermoplastic or a thermoset. The polymer based film may be of, or comprise polyvinyl chloride (PVC), polyester, polypropylene (PP), polyethylene (PE), polystyrene (PS), thermoplastic polyurethane (PU), thermosetting polyurethane (PU), polyethylene terephthalate (PET), polyacrylate, methacrylate, polycarbonate, polyvinyl butyral, polybutylene terephthalate, or a combination thereof.

The protective layer 18 may have a thickness of 0.1-2 mm.

Optionally, a backing layer (not shown) may be applied to a second surface of the substrate 10, opposite the printed polymer based film 1.

The substrate 10, the printed polymer based film 1, and optionally the protective layer 18 and backing layer are adhered to each by applying pressure, for example in a pressing and embossing device 30. In the example shown in FIG. 4, the pressing and embossing device 30 comprises rollers 31 and 32. Heat may also be applied during pressing.

After pressure has been applied by the rollers 31 and 32, a laminated substrate 20 is obtained. The laminated substrate 20 comprises the substrate 10 and the printed polymer based film 1. The laminated substrate 20 may optionally further comprise the protective layer 18 and the backing layer.

In the pressing and embossing device 30, the laminated substrate 20 is provided with an embossed structure by the embossing roller 31. The embossing roller 31 is configured to emboss the laminated substrate 20 with an embossed structure.

The pressing roller 32 may apply counter pressure to the second surface of the substrate 10, opposite the printed polymer based film 1.

The embossing roller 31 is engraved with the embossed structure. The embossing roller 31 has a circumference C3. The circumference surface of the embossing roller 31 is engraved with the embossed structure.

The embossing roller 31 may have a rotation axis which may be arranged parallel to a width direction of the printed polymer based film 1. The embossing roller 31 may have length extension parallel to the width direction of the printed polymer based film 1. The embossing roller 31 may have a rotation axis substantially transverse to the length direction of the polymer based film 1.

The embossing roller 31 may have a rotation axis substantially parallel to the rotation axis of the first and second gravure cylinders 2, 4.

In the example wherein the polymer based film 1 has been printed by rotogravure, as described above with reference to FIG. 1, the circumference C3 of the embossing roller may substantially corresponds to the circumference C1 of the first gravure cylinder 2, or to the circumference C2 of the second gravure cylinder 4. For example, the circumference C3 of the embossing roller may differ from the circumference C1 of the first gravure cylinder 2, or from the circumference C2 of the second gravure cylinder 4, by less than less than 5 mm, such as less that 3 mm, such as less than 1 mm.

If the circumference C3 and the embossed structure of the embossing roller 31 corresponds to the circumference C1 and engraved pattern of the first gravure cylinder 2, the embossed structure may be in register, or at least partly in register, with the first pattern 11 printed by the first gravure cylinder 2. The pattern 11 printed by the first gravure cylinder 2 may be a main pattern, such that the embossed structure is in register, or at least partly in register, with the main pattern.

The embossed structure may not be in register, or at least not be completely in register, with the second pattern 12 formed by the second gravure cylinder 4.

As described above with reference to FIGS. 3A-C, the first pattern 11 may comprise a first set of design elements. The embossed structure may be in register, or at least partly in register, with the first set of design elements. The embossed structure may not in register, or at least being not completely in register, with the second set of design elements of the second pattern 12, formed by the second gravure cylinder 4.

In another example, the circumference C3 and the embossed structure of the embossing roller 31 may correspond, or substantially correspond, to the circumference C2 and engraved pattern of the second gravure cylinder 4, the embossed structure may be in register, or at least partly in register, with the second pattern 12 printed by the second gravure cylinder 4. The second pattern 12 printed by the second gravure cylinder 4 may be a main pattern, such that the embossed structure is in register, or at least partly in register, with the main pattern.

The embossed structure may not be in register, or at least not be completely in register, with the first pattern 11 formed by the first gravure cylinder 2.

As described above with reference to FIGS. 3A-C, the second pattern 12 may comprise a second set of design elements. The embossed structure may be in register, or at least partly in register, with the second set of design elements. The embossed structure may not in register, or at least being not completely in register, with the first set of design elements of the first pattern 11, formed by the first gravure cylinder 2.

If the polymer based film 1 has been printed by a combination of rotogravure and digital printing, as described above with reference to FIG. 2, the circumference C3 of the embossing roller may substantially correspond the circumference C1 of the first gravure cylinder 2.

If the circumference C3 and embossed structure of the embossing roller 31 corresponds to the circumference C1 and engraved pattern of the first gravure cylinder 2, the embossed structure may be in register, or at least partly in register, with the first pattern 11 printed by the first gravure cylinder 2. The pattern 11 printed by the first gravure cylinder 2 may be a main pattern, such that the embossed structure is in register, or at least partly in register, with the main pattern.

As described above with reference to FIGS. 3A-C, the first pattern 11 may comprise a first set of design elements. The embossed structure may be in register, or at least partly in register, with the first set of design elements.

The digital printing process, for example inkjet printing, may print a second set of design elements forming the second pattern 12, as described above with reference to FIG. 2. The embossed structure may not in register, or at least being not completely in register, with the second set of design elements of the second pattern 12, printed by digital printing.

In another example, the circumference C3 and embossed structure of the embossing roller 31 may correspond to the pattern and pattern repetition length R2 of the second pattern 12, such that the embossed structure is in register, or at least partly in register, with the second pattern 12. The second set of design elements 12, forming the second pattern 12, may be in register, or at least partly in register with, the embossed structure.

After embossing, an embossed laminated substrate 20 is obtained. The laminated substrate 20 can be further divided into panels, which will be described with reference to FIGS. 6-8.

FIG. 5 shows an example of a continuous process similar to the process in FIG. 4. In FIG. 5, the arrangement of rollers is different from the arrangement of rollers in FIG. 4. In all other aspects, the disclosure above for FIG. 4 is applicable also for the example in FIG. 4. In FIG. 5, after extrusion, the substrate 10 of the above the described type is calendered by passing one or more calender rollers 17a, 17b such that the substrate 10 obtains a desired thickness. The substrate 10 is thereafter feed over roller 17c. The printed polymer based film 1 of the above described type and the optional protective layer 18 is applied to the substrate 10 and fed between the rollers 17c and 17d.

As described above, the substrate 10, the printed polymer based film 1, and optionally the protective layer 18 and backing layer are adhered to each by applying pressure, for example in a pressing and embossing device 30. In the example shown in FIG. 5, the pressing and embossing device 30 comprises rollers 31 and 32. Heat may also be applied during pressing.

After pressure has been applied by the rollers 31 and 32, a laminated substrate 20 is obtained. The laminated substrate 20 comprises the substrate 10 and the printed polymer based film 1. The laminated substrate 20 may optionally further comprise the protective layer 18 and the backing layer.

In the pressing and embossing device 30, the laminated substrate 20 is provided with an embossed structure by the embossing roller 31. The embossing roller 31 is configured to emboss the laminated substrate 20 with an embossed structure.

The pressing roller 32 may apply counter pressure on the second surface of the substrate 10, opposite the printed polymer based film 1.

The embossing roller 31 is engraved with the embossed structure. The embossing roller 31 has a circumference C3. The circumference surface of the embossing roller 31 is engraved with the embossed structure. The embossing roller 31 may correspond to the embossing roller 31 in FIG. 4, and the disclosure with reference to FIG. 4 is applicable also for the embossing roller in FIG. 5.

FIG. 6 shows another example of a process for forming a laminated substrate. In the process shown in FIG. 6, a substrate 10′ is provided. The substrate 10′ may be formed in a prior process. The substrate 10′ may be pressed, for example by calendering a number of layers, which together form the substrate 10′.

The substrate 10′ may comprise a polymer based material. The polymer based material may be a thermoplastic or a thermoset. The polymer based material may be, or comprise polyvinyl chloride (PVC), polyester, polypropylene (PP), polyethylene (PE), polystyrene (PS), thermoplastic polyurethane (PU), thermosetting polyurethane (PU), polyethylene terephthalate (PET), polyacrylate, methacrylate, polycarbonate, polyvinyl butyral, polybutylene terephthalate, or a combination thereof. The substrate 10′ may comprise 10-60 wt % of the polymer material.

The substrate 10′ may further comprises fillers. The fillers may be organic and/or inorganic. The organic fillers may be wood dust, grounded risk husk, cork, bamboo dust. The inorganic fillers may be calcium carbonate, chalk, limestone, talc, stone dust, fly ash. The substrate 10 may comprise 30-90 wt % of said fillers. The substrate 10′ may comprise 30-90 wt % of said fillers.

The substrate 10′ may further comprise additives, such as impact modifier, stabilizers, lubricants, pigments, foaming agent, and/or plasticizer. The substrate 10 may further comprise pigments.

The substrate 10′ may have a thickness of 2-10 mm.

In one example, the substrate 10 may comprise 10-30 wt % PVC, 50-90 wt % chalk, and 0-20 wt % additives. Such a substrate 10 may be of a type conventionally referred to as SPC.

The printed polymer based film 1 described above is applied on a first surface of the substrate 10. The polymer based film 1 may have been printed by rotogravure printing as described above with reference to FIG. 1, or may have been printed by combined rotogravure printing and digital printing as described above with reference to FIG. 2.

The printed polymer based film 1 may be applied on the substrate 10′ such as that the length direction of the printed polymer based film 1 is substantially parallel to a length direction of the substrate 10′.

In FIG. 6, a protective layer 18 is applied on the printed polymer based film 1. The protective layer 18 may be a protective film, such as a polymer based film. The polymer material of the protective film may be a thermoplastic or a thermoset. The polymer based film may be of, or comprise polyvinyl chloride (PVC), polyester, polypropylene (PP), polyethylene (PE), polystyrene (PS), thermoplastic polyurethane (PU), thermosetting polyurethane (PU), polyethylene terephthalate (PET), polyacrylate, methacrylate, polycarbonate, polyvinyl butyral, polybutylene terephthalate, or a combination thereof.

The protective layer 18 may have a thickness of 0.1-2 mm.

Optionally, a backing layer (not shown) may be applied to a second surface of the substrate 10′, opposite the printed polymer based film 1.

The substrate 10′, the printed polymer based film 1, and optionally the protective layer 18 and backing layer are adhered to each by applying pressure, for example in an embossing and pressing device 30. In the example shown in FIG. 5, the pressing device 30 comprises a double belt press 33, 34. Heat may also be applied during pressing.

The upper belt 33 of the double belt press is provided with an embossed structure, forming an embossing belt, such that pressing and embossing takes place in one process step.

After passing the pressing device 30, a laminated substrate 20 has been obtained. The laminated substrate 20 comprises the substrate 10′ and the printed polymer based film 1. The laminated substrate 20 may optionally further comprise the protective layer 18 and the backing layer. The laminated substrate 20 is provided with an embossed structure.

In the example shown in FIG. 6, embossing takes place simultaneously as pressing, and thereby, forming the laminated substrate 20.

The embossed structure of the upper press belt 33 is configured to emboss the laminated substrate 20 with an embossed structure. The uppermost layer may be the printed polymer based film 1.

The embossed press belt 33, forming the embossing belt, has a perimeter C4. The embossed press belt 33 is engraved with the embossed structure. The perimeter C4 of the embossed press belt 33, forming the embossing belt, is engraved with the embossed structure. The perimeter surface of the embossed press belt 33 may be defined as the length of the surface intended to contact the uppermost layer of the laminated substrate 20.

The embossed press belt 33 has a length extension parallel to the length direction of the printed polymer based film 1.

In the example wherein the polymer based film 1 has been printed by rotogravure, as described above with reference to FIG. 1, the circumference C4 of the embossed press belt 33 may substantially correspond to the circumference C1 of the first gravure cylinder 2, or to the circumference C2 of the second gravure cylinder 4.

If the circumference C4 and the embossed structure of the embossed press belt 33 corresponds to the circumference C1 and pattern of the first gravure cylinder 2, the embossed structure may be in register, or at least partly in register, with the first pattern 11 printed by the first gravure cylinder 2. The pattern 11 printed by the first gravure cylinder 2 may be a main pattern, such that the embossed structure is in register, or at least partly in register, with the main pattern.

The embossed structure may not be in register, or at least not be completely in register, with the second pattern 12 formed by the second gravure cylinder 4.

As described above with reference to FIGS. 3A-C, the first pattern 11 may comprise a first set of design elements. The embossed structure may be in register, or at least partly in register, with the first set of design elements. The embossed structure may not in register, or at least being not completely in register, with the second set of design elements of the second pattern 12, formed by the second gravure cylinder 4.

In another example, the circumference C4 and the embossed structure of the embossed press belt 33 may correspond to the circumference C2 and pattern of the second gravure cylinder 4, the embossed structure may be in register, or at least partly in register, with the second pattern 12 printed by the second gravure cylinder 4. The second pattern 12 printed by the second gravure cylinder 4 may be a main pattern, such that the embossed structure is in register, or at least partly in register, with the main pattern.

The embossed structure may not be in register, or at least not be completely in register, with the first pattern 11 formed by the first gravure cylinder 2.

As described above with reference to FIGS. 3A-3C, the second pattern 12 may comprise a second set of design elements. The embossed structure may be in register, or at least partly in register, with the second set of design elements. The embossed structure may not in register, or at least being not completely in register, with the first set of design elements of the first pattern 11, formed by the first gravure cylinder 2.

If the polymer based film 1 has been printed by a combination of rotogravure and digital printing, as described above with reference to FIG. 2, the circumference C4 of the embossed press belt 33 may substantially correspond the circumference C1 of the first gravure cylinder 2.

If the circumference C4 and embossed structure of the embossed press belt 33 corresponds to the circumference C1 and pattern of the first gravure cylinder 2, the embossed structure is in register, or at least partly in register, with the first pattern 11 printed by the first gravure cylinder 2. The pattern 11 printed by the first gravure cylinder 2 may be a main pattern, such that the embossed structure is in register, or at least partly in register, with the main pattern.

As described above with reference to FIGS. 3A-C, the first pattern 11 may comprise a first set of design elements. The embossed structure may be in register, or at least partly in register, with the first set of design elements.

The digital printing process, for example inkjet printing, may print a second set of design elements forming the second pattern 12, as described above with reference to FIG. 2. The embossed structure may not in register, or at least being not completely in register, with the second set of design elements of the second pattern 12, printed by digital printing.

In another example, the circumference C4 and embossed structure of the embossed press belt 33 may correspond to the pattern and pattern repetition length R2 of the second pattern 12, such that the embossed structure is in register, or at least partly in register, with the second pattern 12. The second set of design elements 12, forming the second pattern 12, may be in register, or at least partly in register with, the embossed structure.

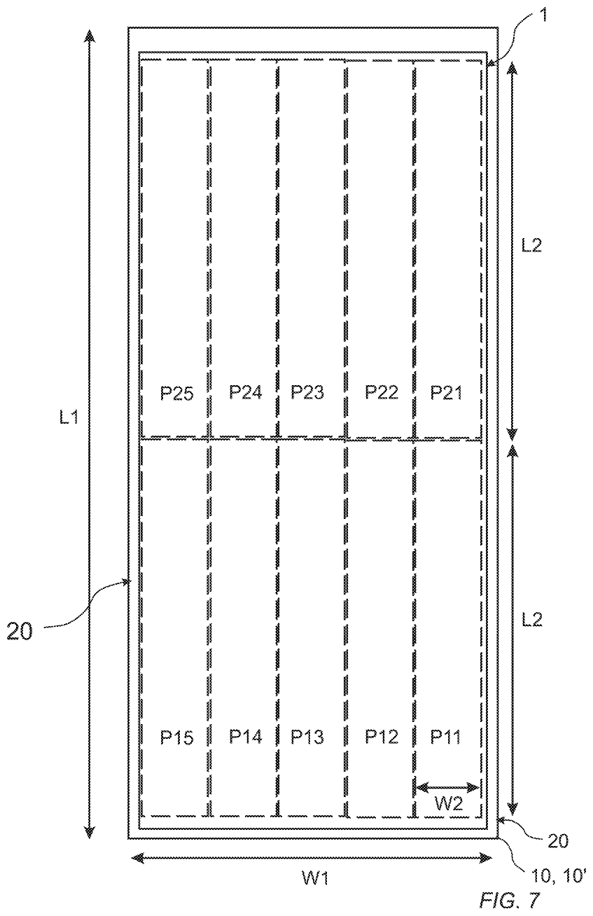

After embossing, an embossed laminated substrate 20 is obtained. The laminated substrate 20 can be further divided into panels, which will be described with reference to FIGS. 7-9.

After embossing, a coating (not shown) may be applied to the printed polymer film 1, or to the protective layer 18 if such a layer has been applied.

FIG. 7 shows an example of the laminated substrate 20 after pressing and embossing as seen from above. The laminated substrate 20 comprises the substrate 10; 10′ and the printed polymer based film 1. The laminated substrate 20 may be formed by any of the methods described above with reference to FIGS. 4-6. A planar extension of the polymer based film 1 substantially corresponds to a planar extension of the substrate 10. In the example shown in FIG. 7, the laminated substrate 20 has rectangular shape, having a length L1 and a width W1. In the example shown in FIG. 7, the length L1 is exceeding the width W1 of the laminated substrate 20. The length direction of the polymer based film 1 is substantially parallel with the length direction of the substrate 10.

The laminated substrate 20 is intended to be divided into panels, which are shown with dashed lines in FIG. 7. The laminated substrate 20 is divided into panels, for example, by sawing. The panels may further be provided with a mechanical locking system. When dividing the laminated substrates into panels, a distance required for dividing the laminated substrate 20 into individual panels, and/or a distance required for machining a mechanical locking system along edges of the panels, may be taken into consideration.

The panels may be tiles or planks. In the example shown in FIG. 7, the panels are plank-shaped, i.e., having a length L2 exceeding a width W2. In the example shown in FIG. 7, the length direction of the planks is substantially parallel to the length direction of the laminated substrate 20. Each panel may have an equal length L2 and equal width W2.

In the example shown in FIG. 7, the laminated substrate 20 is intended to be divided into 10 panels P11, P12, P13, P14, P15, P21, P22, P23, P24, P25. In FIG. 7, the laminated substrate 20 is intended to be divided into panels arranged in a first row of the panels P11, P12, P13, P14, P15 and in a second row of panels P21, P22, P23, P24, P25 arranged subsequent the first row of the panels in the length direction of the laminated substrate 20.

In one example, the panels may have a width of 178 mm and a length of 1219 mm (7×48″). If extruding the substrate 10 in an extruder having a width of approximately 1 m, 5 panels having a width of 178 mm may be provided side by side in the width direction of the substrate 10, as shown in FIG. 7. The panels shown in FIG. 6 may have a length of 1219 mm.

If an extruder having a width of approximately 1.3 m is used for extruding the substrate 10, 7 panels having a width of 178 mm may be provided side by side in the width direction of the substrate 10. Correspondingly, such a laminated substrate may be intended to be divided into 14 panels.

In another example, the panels may have a width of 305 mm and a length of 610 mm (12×24″).

In further examples, the panels may have a width of 229 mm and a length of 1524 mm (9×60″). In other examples, the panels may be tiles having a width and length of 457 mm (18×18″).

The laminated substrate 20 is intended to be divided into panel having a length substantially corresponding to the perimeter of the embossing device, either in form of the embossed roller 31 having the circumference C3 or in form of the embossing press belt 33 having the circumference C4.

If the circumference C3, C4 of the embossing device corresponds to the circumference C1 of the first gravure cylinder 2, the length of the panels will substantially correspond to the length R1 of the first pattern 11.

If the circumference C3, C4 of the embossing device corresponds to the circumference C2 of the second gravure cylinder 2 or to a pattern repetition length of a digitally printed pattern, the length of the panels will substantially correspond to the length R2 of the second pattern 12.

By the first pattern 11 and the second pattern 12 not having the same length, the pattern of the panels will not be identical. Thereby, the numbers of non-identical panels obtained from substrate will be increased.

In one example, the first pattern 11 forms a main pattern. The first pattern 11 may be printed by the first gravure cylinder 2, having the circumference C1. The length of each panel corresponds to the circumference C1 of the first gravure cylinder 2. The length of each panel may correspond to the length of the first pattern 11. Thereby, each panel is provided with the first pattern 11. In addition to the first pattern 11, the second pattern 12 adds certain design elements to the first pattern 11. As the second pattern is printed by the second gravure cylinder 4 having the circumference C2, exceeding the circumference C1 of the first gravure cylinder 2, repetition of the second pattern 12 does not coincide with the repetition of the first pattern 11. Thereby the combined pattern of each panel will be unique.

As an alternative, the second set of design elements may be printed by digital printing, thus offering the possibility of avoiding any repetition of the second pattern 12.

In the example shown in FIG. 7, 10 panels with non-identical patterns are obtained. In known solutions, only 5 panels with non-identical patterns would be obtained.

The embossed structure may be in register, or at least partly in register, with at least a portion of the pattern of the panels. As described above, the pattern of the panel may be at least in register with the first pattern or with the second pattern.

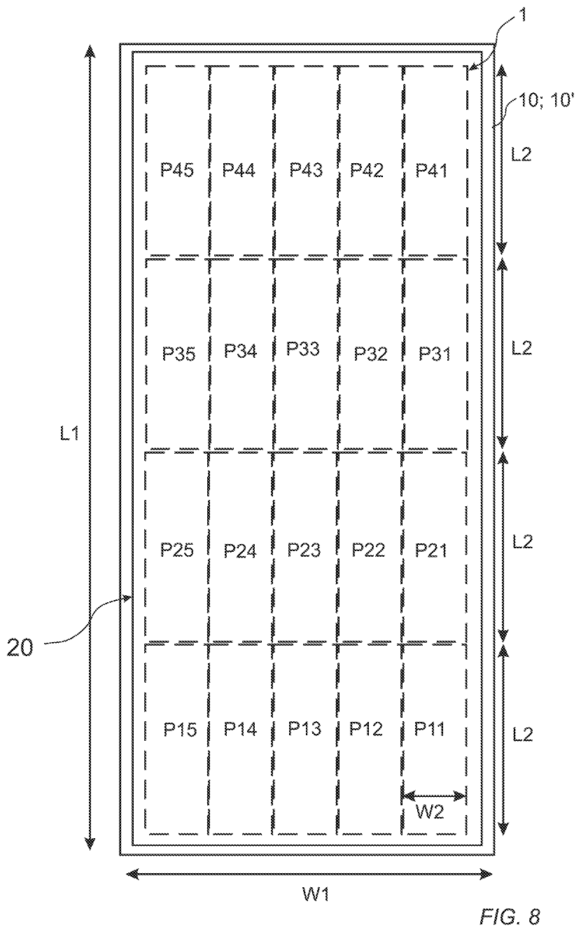

FIG. 8 shows a second example of the laminated substrate 20 after pressing and embossing as seen from above. The laminated substrate 20 comprises the substrate 10; 10′ and the printed polymer based film 1. The laminated substrate 20 may be formed by any other the methods described above with reference to FIGS. 4-6. A planar extension of the polymer based film 1 substantially corresponds to a planar extension of the substrate 10. In the example shown in FIG. 8, the laminated substrate 20 has rectangular shape, having a length L1 and a width W1. In the example shown in FIG. 8, the length L1 is exceeding the width W1 of the laminated substrate 20. The length direction of the polymer based film 1 is substantially parallel with the length direction of the substrate 10.

The laminated substrate 20 is intended to be divided into panels, which are shown with dashed lines in FIG. 8. The laminated substrate 20 is divided into panels, for example, by sawing. The panels may further be provided with a mechanical locking system. When dividing the laminated substrates into panels, a distance required for dividing the laminated substrate 20 into individual panels, and/or a distance required for machining a mechanical locking system along edges of the panels, may be taken into consideration.

The panels may be tiles or planks. In the example shown in FIG. 8, the panels are plank-shaped, i.e., having a length L2 exceeding a width W2. In the example shown in FIG. 8, the length direction of the planks is substantially parallel to the length direction of the laminated substrate 20. Each panel may have an equal length L2 and width W2.

In the example shown in FIG. 8, the laminated substrate 20 is intended to be divided into 20 panels P11, P12, P13, P14, P15, P21, P22, P23, P24, P25, P31, P32, P33, P34, P35, P41, P42, P43, P44, P45. In FIG. 8, the laminated substrate 20 is intended to be divided into panels arranged in a first row of panels, including panels P11, P12, P13, P14, P15, in a second row of panels, including panels P21, P22, P23, P24, P25, in a third row panels, including panels P31, P32, P33, P34, P35, and in a fourth row of panels, including panels P41, P42, P43, P44, P45. The rows of panels are arranged subsequent each other in the length direction of the laminated substrate 20.

In one example, the panels may have a width of 178 mm and a length of 1219 mm (7×48″). If extruding the substrate 10 in an extruder having a width of approximately 1 m, 5 panels having a width of 178 mm may be provided side by side in the width direction of the substrate 10, as shown in FIG. 8.

If an extruder having a width of approximately 1.3 m is used for extruding the substrate 10, 7 panels having a width of 178 mm may be provided side by side in the width direction of the substrate 10. Correspondingly, such a laminated substrate may be intended to be divided into 28 panels.

In another example, the panels may have a width of 305 mm and a length of 610 mm (12×24″).

In further examples, the panels may have a width of 229 mm and a length of 1524 mm (9×60″). In other examples, the panels may be tiles having a width and length of 457 mm (18×18″).

The laminated substrate 20 is intended to be divided into panel having a length substantially corresponding to the perimeter of the embossing device, either in form of the embossed roller 31 having the circumference C3 or in form of the embossing press belt 33 having the circumference C4.

If the circumference C3, C4 of the embossing device corresponds to the circumference C1 of the first gravure cylinder 2, the length of the panels will substantially correspond to the length R1 of the first pattern 11.

If the circumference C3, C4 of the embossing device corresponds to the circumference C2 of the second gravure cylinder 2 or to a pattern repetition length of a digitally printed pattern, the length of the panels will substantially correspond to the length R2 of the second pattern 12.

By the first pattern 11 and the second pattern 12 not having the same length, the pattern of the panels will not be identical. Thereby, the numbers of non-identical panels obtained from substrate will be increased.

In one example, the first pattern 11 forms a main pattern. The first pattern 11 may be printed by the first gravure cylinder 2, having the circumference C1. Each panel has the first pattern 11. The length of each panel corresponds to the circumference C1 of the first gravure cylinder 2. The length of each panel may correspond to the length of the first pattern 11. Thereby, each panel is provided with the first pattern 11.

In addition to the first pattern 11, the second pattern 12 adds certain design elements to the first pattern 11. As the second pattern is printed by the second gravure cylinder 4 having the circumference C2, exceeding the circumference C1 of the first gravure cylinder 2, repetition of the second pattern 12 does not coincide with the repetition of the first pattern 11, thereby the combined pattern of each panel will be unique.

As an alternative, the second set of design elements may be printed by digital printing, thus offering the possibility of avoiding any repetition of the second pattern 12.

In the example shown in FIG. 8, 20 panels with non-identical patterns are obtained. In known solutions, only 5 panels with non-identical patterns would be obtained.

The embossed structure may be in register, or at least partly in register, with at least a portion of the pattern of the panels. As described above, the pattern of the panel may be at least in register with the first pattern or with the second pattern.

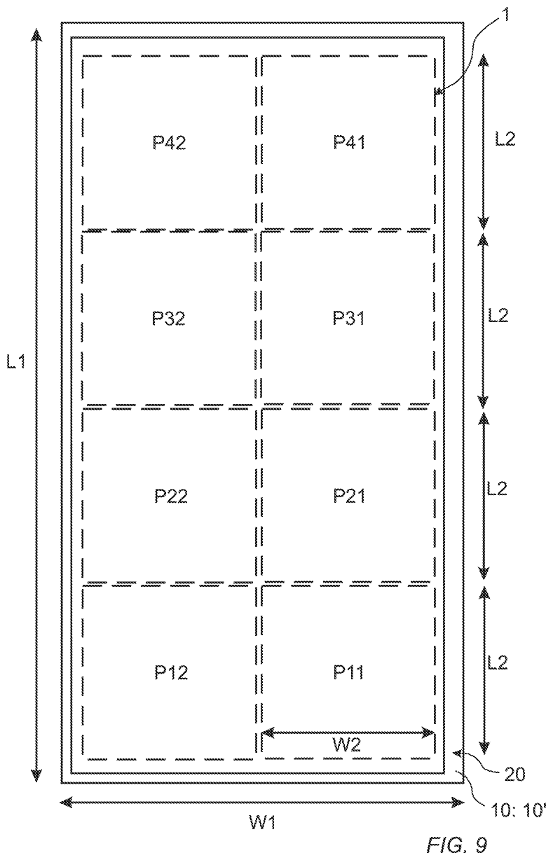

FIG. 9 shows a second example of the laminated substrate 20 after pressing and embossing as seen from above. The laminated substrate 20 comprises the substrate 10; 10′ and the printed polymer based film 1. The laminated substrate 20 may be formed by any other the methods described above with reference to FIGS. 4-6. A planar extension of the polymer based film 1 substantially corresponds to a planar extension of the substrate 10. In the example shown in FIG. 9, the laminated substrate 20 has rectangular shape, having a length L1 and a width W1. In the example shown in FIG. 9, the length L1 is exceeding the width W1 of the laminated substrate 20. The length direction of the polymer based film 1 is substantially parallel with the length direction of the substrate 10.

The laminated substrate 20 is intended to be divided into panels, which are shown with dashed lines in FIG. 9. The laminated substrate 20 is divided into panels, for example, by sawing. The panels may further be provided with a mechanical locking system. When dividing the laminated substrates into panels, a distance required for dividing the laminated substrate 20 into individual panels, and/or a distance required for machining a mechanical locking system along edges of the panels, may be taken into consideration.

The panels may be tiles or planks. In the example shown in FIG. 9, the panels are tile-shaped, i.e., having a length L2 being substantially similar to its width W2. Each panel may have an equal length L2 and equal width W2.

In the example shown in FIG. 9, the laminated substrate 20 is intended to be divided into 8 tiles P11, P12, P21, P22, P31, P32, P41, P42. In FIG. 9, the laminated substrate 20 is intended to be divided into tiles arranged in a first row of tiles, including tiles P11, P12, in a second row of tiles, including tiles P21, P22, in a third row of tiles, including tiles P31, P32, and in a fourth row of tiles, including tiles P41, P42. The rows of tiles are arranged subsequent each other in the length direction of the laminated substrate 20.

In one example, the tiles may be tiles having a width and length of 457 mm (18×18″).

The laminated substrate 20 is intended to be divided into tiles having a length substantially corresponding to the perimeter C3; C4 of the embossing device 30, either in form of the embossed roller 31 having the circumference C3 or in form of the embossing press belt 33 having the circumference C4. Alternatively, the length of the tile may correspond to a portion of the perimeter C3; C4 of the embossing device 30.

If the circumference C3, C4 of the embossing device corresponds to the circumference C1 of the first gravure cylinder 2, the length of the tiles will substantially correspond to the length R1 of the first pattern 11.

If the circumference C3, C4 of the embossing device corresponds to the circumference C2 of the second gravure cylinder 2 or to a pattern repetition length of a digitally printed pattern, the length of the panels will substantially correspond to the length R2 of the second pattern 12.

If the polymer based film 1 is printed by the first gravure cylinder 2 or second gravure cylinder 4 having a pattern repetition comprising more than one pattern, the length of the tile may correspond to the length of each individual pattern in the pattern repetition.

By the first pattern 11 and the second pattern 12 not having the same length, the pattern of the panels will not be identical. Thereby, the numbers of non-identical panels obtained from substrate will be increased.

In one example, the first pattern 11 forms a main pattern. The first pattern 11 may be printed by the first gravure cylinder 2, having the circumference C1. Each panel has the first pattern 11. In addition to the first pattern 11, the second pattern 12 adds certain design elements to the first pattern 11. As the second pattern is printed by the second gravure cylinder 4 having the circumference C2, exceeding the circumference C1 of the first gravure cylinder 2, repetition of the second pattern 12 does not coincide with the repetition of the first pattern 11, thereby the combined pattern of each panel will be unique.

As an alternative, the second set of design elements may be printed by digital printing, thus offering the possibility of avoiding any repetition of the second pattern 12.

In the example shown in FIG. 9, 8 tiles with non-identical embossed structure are obtained. In known solutions, only 2 tiles with non-identical embossed structure would be obtained.

In one example of a panel described above with reference to FIGS. 7-9, the polymer based film 1 is printed by the first gravure cylinder 2, forming the first pattern 11. The polymer based film 1 is printed by the second gravure cylinder 4, forming the second pattern 12. The circumference C2 of the second gravure cylinder 4 exceeds the circumference C1 of the first gravure cylinder 2. The perimeter C3; C4 of the embossing device corresponds to the circumference C1 of the first gravure cylinder 2. The embossed structure of the embossing device is in register with the pattern of the first gravure cylinder 2. The length of the panel corresponds to the circumference C1 of the first gravure cylinder 2.

In the disclosure above, the panel may be intended to be a building panel, such as a floor panel, a furniture component, a worktop, a wall panel, a ceiling panel.

### Item List

Item 1. A method to produce a laminated substrate (20) with an embossed structure, comprising:
   providing a polymer based film (1) having a first pattern (11) printed by at least a first gravure cylinder (2) and a second pattern (12) printed by digital printing,
   applying the polymer based film (1) on a substrate (10; 10′) comprising a polymer based material,
   pressing said polymer based film (1) to the substrate (10; 10′), thereby forming a laminated substrate (20), and
   embossing the laminated substrate (20) by an embossing device (30) such that the laminated substrate (20) obtains an embossed structure, wherein a perimeter (C3; C4) of the embossing device (30) corresponds to a circumference (C1) of the first gravure cylinder (2), or to a pattern repetition length (R2) of the second pattern (12).
Item 2. The method according to item 1, wherein the perimeter (C3; C4) of the embossing device (30) corresponds to the circumference (C1) of the first gravure cylinder (2) such that the first pattern (11) formed by the first gravure cylinder (2) is at least partly in register with the embossed structure.
Item 3. The method according to item 2, wherein the second pattern (12) formed by digital printing is not , or at least not completely, in register with the embossed structure.
Item 4. The method according to any one of the preceding items, wherein the first pattern (11) comprises a first set of design elements and the second pattern (12) comprises a second set of design elements, wherein the embossed structure is in register with the first set of design elements.
Item 5. The method according to item 1, wherein the perimeter (C3; C4) of the embossing device (30) corresponds to the pattern repetition length (R2) of the second pattern (12) such that the second pattern (12) formed by digital printing is in register with the embossed structure.
Item 6. The method according to item 5, wherein the first pattern (11) formed by the first gravure cylinder (2) is not, or at least not completely, in register with the embossed structure.
Item 7. The method according to item 5 or 6, wherein the first pattern (11) comprises a first set of design elements and the second pattern (12) comprises a second set of design elements, wherein the embossed structure is in register with the second set of design elements.
Item 8. The method according to any one of the preceding items, wherein the first pattern (11) and/or the second pattern (12) is a wood grain pattern.
Item 9. The method according to any one of the preceding items, wherein the first pattern (11) or the second pattern (12) adds at least one knot, crack and/or at least one medullary ray to the other of the first pattern (11) or the second pattern (12).
Item 10. The method according to any one of the preceding items, further comprising dividing the laminated substrate (20) into panels, wherein a length (L2) of a panel substantially corresponds to the perimeter (C4; C4) of the embossing device (30).
Item 11. The method according to any one of the preceding items, wherein the substrate (10; 10′) is formed by a continuous process.
Item 12. The method according to any one of the preceding items, wherein the polymer based film (1) is continuously applied on the substrate.
Item 13. The method according to any one of the preceding items, wherein the substrate (10; 10′) is formed by extruding.
Item 14. The method according to any one of the preceding items, further comprising applying a protective layer to said polymer based film (1) prior to embossing.
Item 15. The method according to any one of the preceding items, wherein pressing comprises applying heat and pressure.
Item 16. The method according to any one of the preceding items , wherein the substrate (10; 10′) further comprises fillers, the fillers being one or more of: calcium carbonate, chalk, limestone, talc, stone dust, fly ash, wood dust, grounded risk husk, cork, and bamboo dust.
Item 17. The method according to any one of the preceding items, wherein the polymer based film (1) is a PVC film.

1. A method to produce a laminated substrate with an embossed structure, comprising:
providing a polymer based film printed by at least a first gravure cylinder forming a first pattern and a second gravure cylinder forming a second pattern, wherein a circumference of the second gravure cylinder exceeds a circumference of the first gravure cylinder,
applying the polymer based film on a substrate comprising a polymer based material,
pressing said polymer based film to the substrate, thereby forming a laminated substrate, and
embossing the laminated substrate by an embossing device such that the laminated substrate obtains an embossed structure, wherein a perimeter of the embossing device corresponds to the circumference of the first gravure cylinder or to the circumference of the second gravure cylinder.

2. The method according to claim 1, wherein the perimeter of the embossing device corresponds to the circumference of the first gravure cylinder such that the first pattern formed by the first gravure cylinder is at least partly in register with the embossed structure.

3. The method according to claim 2, wherein the second pattern formed by the second gravure cylinder is not, or is at least not completely, in register with the embossed structure.

4. The method according to claim 1, wherein the first pattern comprises a first set of design elements and the second pattern comprise a second set of design elements, wherein the embossed structure is in register with the first set of design elements.

5. The method according to claim 1, wherein the perimeter of the embossing device corresponds to the circumference of the second gravure cylinder such that at least a part of the second pattern formed by the second gravure cylinder is in register with the embossed structure.

6. The method according to claim 5, wherein the first pattern formed by the first gravure cylinder is not, or is at least not completely, in register with the embossed structure.

7. The method according to claim 5, wherein the first pattern comprises a first set of design elements and the second pattern comprise a second set of design elements, wherein the embossed structure is in register with the second set of design elements.

8. The method according to claim 1, wherein the first pattern and/or the second pattern is a wood grain pattern.

9. The method according to claim 1, wherein the first pattern or the second pattern adds at least one knot, crack and/or medullary ray to the other of the first pattern or the second pattern.

10. The method according to claim 1, further comprises dividing the laminated substrate into panels, wherein a length of a panel substantially corresponds to the perimeter of the embossing device.

11. The method according to claim 1, wherein the substrate is formed by a continuous process.

12. The method according to claim 1, wherein the polymer based film is continuously applied on the substrate.

13. The method according to claim 1, wherein the substrate is formed by extruding.

14. The method according to claim 13, wherein the polymer based film is applied to the substrate prior to cooling the substrate.

15. The method according to claim 1, further comprising applying a protective layer to the polymer based film prior to embossing.

16. The method according to claim 1, wherein pressing comprises applying heat and pressure.

17. The method according to claim 1, wherein the substrate comprises fillers, the fillers being one or more of: calcium carbonate, chalk, limestone, talc, stone dust, fly ash, wood dust, grounded risk husk, cork, bamboo dust.

18. The method according to claim 1, wherein the polymer based film is a PVC film.
